(19) United States
(12) Patent Application Publication
(10) Pub. No.: US 2016/0257249 A1
(43) Pub. Date: Sep. 8, 2016

(54) CONTROL DEVICE AND CONTROL METHOD FOR VEHICLE OPEN-CLOSE MEMBER, AND VEHICLE OPEN-CLOSE MEMBER INCLUDING THE CONTROL DEVICE

(71) Applicant: AISIN SEIKI KABUSHIKI KAISHA, Kariya-shi, Aichi (JP)

(72) Inventors: Hiroshi URASE, Kariya-shi (JP); Eiji ITAMI, Kariya-shi (JP); Takeshi NISHIKIBE, Kariya-shi (JP); Toshiro MAEDA, Kariya-shi (JP)

(73) Assignee: AISIN SEIKI KABUSHIKI KAISHA, Kariya-shi, Aichi-ken (JP)

(21) Appl. No.: 15/032,473

(22) PCT Filed: Sep. 17, 2014
(86) PCT No.: PCT/JP2014/004791

§ 371 Date: Apr. 27, 2016

(30) Foreign Application Priority Data
Oct. 29, 2013 (JP) 2013-224063

(51) Int. Cl. B60Q 9/00; E05F 15/60; B60J 5/06

(52) U.S. Cl. CPC B60Q 9/00; B60J 5/06; E05F 15/60; E05Y 2400/30; E05Y 2900/531

(57) ABSTRACT

An embodiment of the present invention provides a control device for a vehicle open-close member: including a current signal input unit configured to receive an inputted current signal indicating a current value of a current flowing through an electromagnetic clutch of the vehicle open-close member, the electromagnetic clutch being operated with the current supplied from a power supply; a clutch state judgement unit configured to judge that the electromagnetic clutch is in a deteriorated state, if the current signal indicates that the current value is less than a predetermined threshold; and a warning signal output unit configured to output a warning signal to a warning device configured to give a warning to a user, if the clutch state judgement unit judges that the electromagnetic clutch is in the deteriorated state.

### TECHNICAL FIELD

The present invention relates to a control device and control method for a vehicle open-close member, and a vehicle open-close member including the control device.

### BACKGROUND ART

There is known a vehicle open-close member capable of performing automatic open-close operations by means of a motor. The motor for such an open-close member uses an electromagnetic clutch. Patent Document 1 discloses a device in which a failure detector circuit 84 and a controller 66 detect a failure of a solenoid 85, as a driving source for an electromagnetic brake, and a switch transistor 86 (see FIG. 4 and the explanation thereof in Patent Document 1).

The controller 66 outputs a Hi signal or Lo signal from an output port, and measures whether the voltage of a signal inputted to an input port is Hi or Lo. The controller 66 judges whether any of a wire break of the solenoid 85 and a failure of the switch transistor 86 occurs or not, on the basis of a combination of the voltage levels (Hi or Lo).

### CITATION LIST

### Patent Document

Patent Document 1: Japanese Patent Application Laid-Open No. 2003-129748

### SUMMARY OF INVENTION

### Technical Problem

One of failure mechanisms of a coil (solenoid) is caused by an aging deterioration such as coil wire corrosion. As for such a failure cause, a precursory phenomenon, that is, a gradual increase in the electric resistance may be observed prior to a wire break. The electromagnetic brake failure judgement mechanism disclosed in Patent Document 1 judges whether or not a failure occurs based on a measurement result of the voltage level. The failure judgement method in Patent Document 1, however, is only based on two levels of values, Hi and Lo to judge whether a wire break occurs or not, and is not adapted to detect a precursory phenomenon of a failure, such as an increase in the electric resistance. For this reason, in an electromagnetic clutch employing the electromagnetic brake failure judgement mechanism disclosed in Patent Document 1, a failure cannot be judged unless a wire break actually occurs, which means that the occurrence of a failure, itself, cannot be prevented.

Meanwhile, for fail-safe control to prevent an open-close member from opening despite the intention of a user, it is preferable to detect a failure in an electromagnetic clutch and to prevent the failure previously. As an example of the fail-safe control, there is a conceivable safety mechanism which, when a door latch of an open-close member is released despite the intention of a user while a vehicle is running, stops the open-close member from opening by engaging an electromagnetic clutch in response to a signal from the door latch. In such a safety mechanism, if the electromagnetic clutch has a failure, or if the electromagnetic clutch comes to have a failure upon power supply for engagement, the electromagnetic clutch cannot be engaged, and the open-close member may possibly open despite the intention of the user. Hence, also from the perspective of fail-safe control, there is a demand for previous prevention of a failure of an electromagnetic clutch.

The present invention has been made in view of the problems described above, and has an object to provide a control device for a vehicle open-close member, the control device being capable of detecting a coil of an electromagnetic clutch having a deterioration that is a precursory phenomenon of a failure.

### Solution to Problem

In order to achieve the object described above, an embodiment of the present invention provides a control device for a vehicle open-close member, comprising: a current signal input unit configured to receive an inputted current signal indicating a current value of a current flowing through an electromagnetic clutch of the vehicle open-close member, the electromagnetic clutch being operated with the current supplied from a power supply; a clutch state judgement unit configured to judge that the electromagnetic clutch is in a deteriorated state, if the current signal indicates that the current value is less than a predetermined threshold; and a warning signal output unit configured to output a warning signal to a warning device configured to give a warning to a user, if the clutch state judgement unit judges that the electromagnetic clutch is in the deteriorated state.

### Advantageous Effects of Invention

The control device for a vehicle open-close member provided according to the present invention is capable of detecting a coil of an electromagnetic clutch having a deterioration that is a precursory phenomenon of a failure.

### BRIEF DESCRIPTION OF DRAWINGS

FIG. 1 is a schematic side view of a vehicle according to an embodiment of the present invention.

FIG. 2A is a schematic structural view of a slide door according to the embodiment of the present invention.

FIG. 2B is a schematic cross sectional view of an open-close driver device according to the embodiment of the present invention.

FIG. 3 is a block diagram of a control device for a vehicle open-close member according to the embodiment of the present invention.

FIG. 4 is a diagram illustrating a circuit configuration of a current detector circuit according to the embodiment of the present invention.

FIG. 5 is a diagram illustrating a circuit configuration of the control device according to the embodiment of the present invention.

FIG. 6 is a flowchart of a control method according to the embodiment of the present invention.

FIG. 7 is a diagram illustrating a circuit configuration of a current detector circuit according to a modification of the present invention.

FIG. 8 is a flowchart of a control method according to the modification of the present invention.

### DESCRIPTION OF EMBODIMENTS

Hereinafter, an exemplary embodiment for carrying out the present invention is explained in detail with reference to the drawings. It should be noted that dimensions, materials, shapes, relative positions of component elements, and any other things described in the following embodiment are optional ones, and can be altered depending on a structure or various conditions of a device to which the present invention is applied. Moreover, unless otherwise stated, the scope of the present invention should not be limited to modes specifically described in detail in the following embodiment. In addition, component elements having the same function are assigned with the same reference numeral in the drawings explained below, and repetitive explanations thereof are omitted in some cases.

### First Embodiment

### Structure of Vehicle

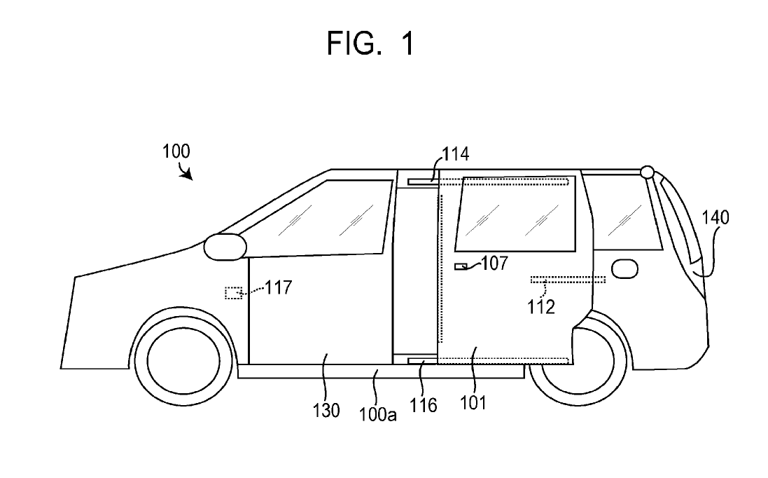

FIG. 1 is a schematic side view of a vehicle 100 according to an embodiment of the present invention. Hereinafter, a structure of the vehicle 100 is described in detail.

The vehicle 100 includes a slide door 101 as a vehicle open-close member. The slide door 101 includes a known open-close mechanism, and is supported on a center rail 112, an upper rail 114, and a lower rail 116 in such a manner that the slide door 101 can move relative to a vehicle body 100a in front-rear directions of the vehicle 100. Note that the vehicle open-close member should not be limited to the slide door 101, but may be a swing door 130 or a back door 140. The vehicle 100 further includes a warning device 117 configured to provide a warning to a user by means of light, sound, or any display.

### <Structure of Vehicle Open-Close Member>

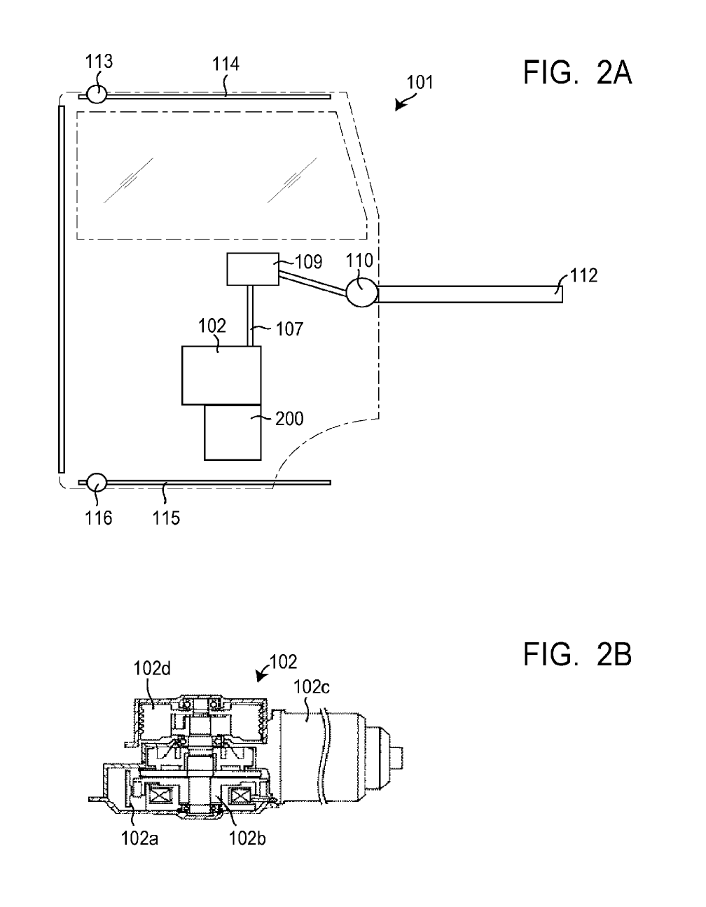

FIG. 2A is a schematic structural view of the slide door 101 as the vehicle open-close member, and FIG. 2B is a schematic cross sectional view of an open-close driver device 102. The structure of the slide door 101 is described below in detail.

The open-close driver device 102 and an electronic control unit (ECU) 200 are attached to the slide door 101. It should be noted that a place to which the ECU 200 is attached is not limited to the slide door 101, but may be any desired place inside the vehicle 100.

The slide door 101 is supported on the center rail 112, the upper rail 114, and the lower rail 116 via a center roller 110, an upper roller 113, and a lower roller 115, respectively, in such a manner as to be movable in the front-rear directions of the vehicle 100.

The ECU 200 inverts the polarity of a voltage to be applied to an open-close motor 102c by controlling a relay inside an output circuit connected to the open-close driver device 102. With this operation, the rotation direction of the open-close motor 102c is changed, and the open/close direction of the slide door 101 is controlled. Here, when an electromagnetic clutch 102b is in a disengaged state, in other words, a disconnected state, a user can open or close the slide door 101 manually.

The electromagnetic clutch 102b includes a coil as a driving source. The engagement and disengagement of the electromagnetic clutch 102b can be switched by use of an electromagnetic force generated when the coil is supplied with the electric power.

A pulse sensor 102a is a hall element or the like, and outputs a pair of pulse signals out of phase from each other to the ECU 200. The ECU 200 is able to detect a rotation amount, a rotational speed, and a rotation direction of the open-close motor 102c based on the pulse signals, and to judge a position, a moving speed and a moving direction of the slide door 101.

As illustrated in FIG. 2B, the open-close driver device 102 includes a driving mechanism including the pulse sensor 102a, the electromagnetic clutch 102b, the open-close motor 102c, and a drum 102d. One end of a cable 107 is fixed to the drum 102d, while the other end of the cable 107 is fixed to the vehicle body 100a with the cable 107 guided through a guide pulley 109 and the center rail 112. In this structure, the ECU 200 brings the electromagnetic clutch 102b into engagement, i.e., turns the electromagnetic clutch 102b into the connected state, and drives the open-close motor 102c. By this operation, the motive power of the open-close motor 102c is transmitted to the slide door 101 via the electromagnetic clutch 102b, the drum 102d, and the cable 107. In this way, the open-close driver device 102 is capable of opening and closing the slide door 101 by driving according to control signals outputted from the ECU 200.

### <Structure of Control Device for Vehicle Open-Close Member>

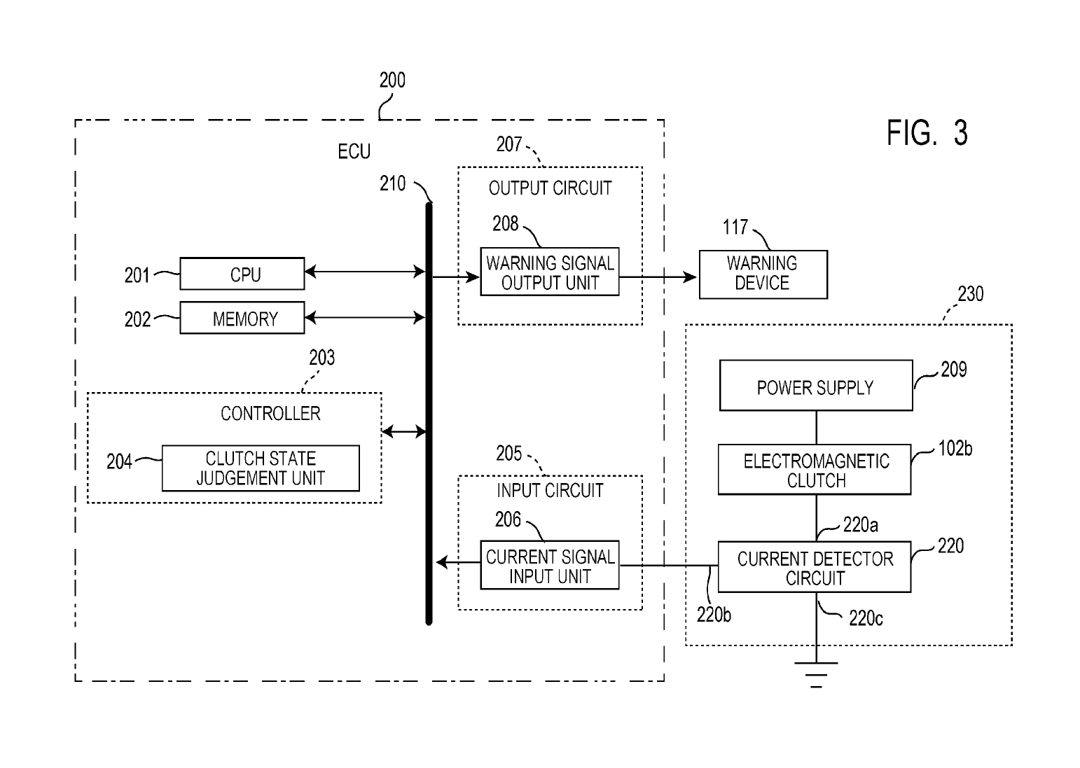

FIG. 3 is a block diagram of the ECU 200 as a control device for the vehicle open-close member, and others. Hereinafter, the structure of the ECU 200 as the control device for a vehicle open-close member is described in detail.

The ECU 200 includes a central processing unit (CPU) 201, a memory 202, a controller 203, an input circuit 205, an output circuit 207, and a system bus 210. The controller 203 has predetermined functions to process signals inputted to the ECU 200 and control the warning device 117 in collaboration with the CPU 201 and the memory 202. Here, the controller 203 may be a software program stored inside the memory 202 and having the functions to be executed by the CPU 201 written therein, or be a hardware element mounted inside the ECU 200. In addition, the ECU 200 may further include hardware elements such as a counter circuit and an oscillator to provide a clock frequency to the CPU 201.

The controller 203 includes a clutch state judgement unit 204. The component elements in the ECU 200 exchange signals with each other via the system bus 210.

The CPU 201 performs computation processes to implement predetermined functions, while the memory 202 includes a read only memory (ROM) for storing programs, a random access memory (RAM) for temporary storage, and the like.

The input circuit 205 receives a signal inputted from an output terminal 220b of a current detector circuit 220. The input circuit 205 includes a current signal input unit 206. The current signal input unit 206 converts the inputted signal into a digital signal processable by the CPU 201.

The output circuit 207 includes a warning signal output unit 208. The warning signal output unit 208 converts a signal inputted via the system bus 210 to an analog signal, and outputs the analog signal as a control signal to the warning device 117.

The clutch state judgement unit 210 monitors the electromagnetic clutch 102b, and judges that the electromagnetic clutch 102b has a failure or a deterioration that is a precursory phenomenon of the failure.

The controller 203 outputs a control signal for controlling the warning device 117 based on the judgement result in the clutch state judgement unit 204. The warning device 117 preforms a predetermined operation according to the control signal outputted from the ECU 200.

An electromagnetic clutch circuit 230 includes the electromagnetic clutch 102b, the current detector circuit 220, and a power supply 209. One terminal of the electromagnetic clutch 102b is connected to the power supply 209 and receives electric power from the power supply 209. The other terminal of the electromagnetic clutch 102b is connected to the ground via the current detector circuit 220. The current detector circuit 220 includes an input terminal 220a connected to the electromagnetic clutch 102b, the output terminal 220b connected to the current signal input unit 206 of the input circuit 205, and a ground terminal 220c connected to the ground. Here, a functional block (not illustrated) inside the controller 203 and a functional block (not illustrated) inside the output circuit 207 in the ECU 200 perform control of electric power supply from the power supply 209 to the electromagnetic clutch 102b, and control of connection/disconnection of the electromagnetic clutch 102b.

### <Schematic Configuration of Current Detector Circuit>

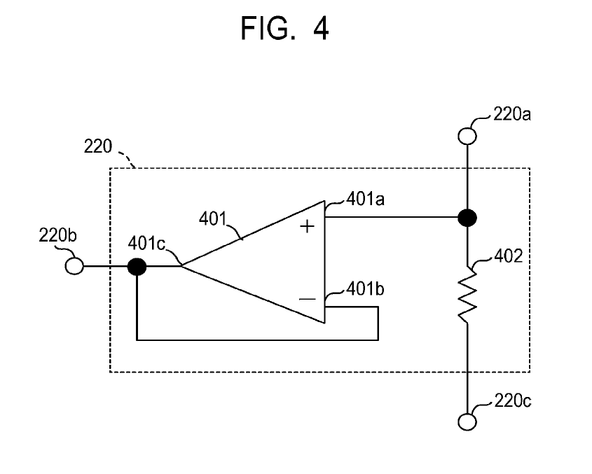

FIG. 4 illustrates a schematic configuration for explaining a principle of current detection in the current detector circuit 220. The current detector circuit 220 includes an operational amplifier 401 and a resistor 402. The operational amplifier 401 includes a non-inverting input terminal 401a, an inverting input terminal 401b, and an output terminal 401c. The non-inverting input terminal 401a is connected to one terminal of the resistor 402, and constitutes the input terminal 220a of the current detector circuit 220. The inverting input terminal 401b is connected to the output terminal 401c, and constitutes the output terminal 220b of the current detector circuit 220. The other terminal of the resistor 402 constitutes the ground terminal 220c.

The current detector circuit 220 is formed as a voltage follower circuit using the operational amplifier 401. Thus, in the current detector circuit 220, the output terminal 220b has the same potential as the input terminal 220a. In addition, the operational amplifier 401 has such a high input impedance that the current flowing from the input terminal 220a to the output terminal 220b in the current detector circuit 220 can be ignored, and the current flowing through the resistor 402 is equivalent to the current flowing through the electromagnetic clutch 102b. In the configuration described above, a voltage V detected at the output terminal 220b of the current detector circuit 220 is V=IR, where I denotes a current flowing through the electromagnetic clutch 102b, and R denotes a resistance value of the resistor 402. In other words, the current detector circuit 220 functions as a current-voltage convertor circuit which outputs, to the output terminal 220b, a voltage proportional to the current flowing through the electromagnetic clutch 102b without influencing the driving of the electromagnetic clutch 102b. If the voltage outputted to the output terminal 220b becomes lower than a predetermined voltage, it can be inferred that the amount of current flowing through the electromagnetic clutch 102b becomes smaller due to an increase in the resistance of the coil of the electromagnetic clutch 102b. Presumably, this indicates a deterioration of the electromagnetic clutch 102b that is a precursory phenomenon of a failure.

Here, FIG. 4 only illustrates the operational amplifier 401 and the resistor 402 for the sake of simplification of explanation. The current detector circuit 220 may also additionally include capacitors, resistors, diodes, and the like for the purposes such as noise cancellation, surge suppression, and anomalous-oscillation prevention. The output terminal 220b of the current detector circuit 220 may additionally include a constant voltage circuit using a zener diode or the like for limiting the output voltage to a predetermined range.

The above description illustrates the current detector circuit 220 using a voltage follower circuit that does not amplify the voltage. Instead, the output voltage may be amplified by using an inverting amplifier circuit or a non-inverting amplifier circuit. When the output voltage is amplified, the measureable range of the current detector circuit 220 can be expanded.

### <Electromagnetic Clutch and Control Circuit>

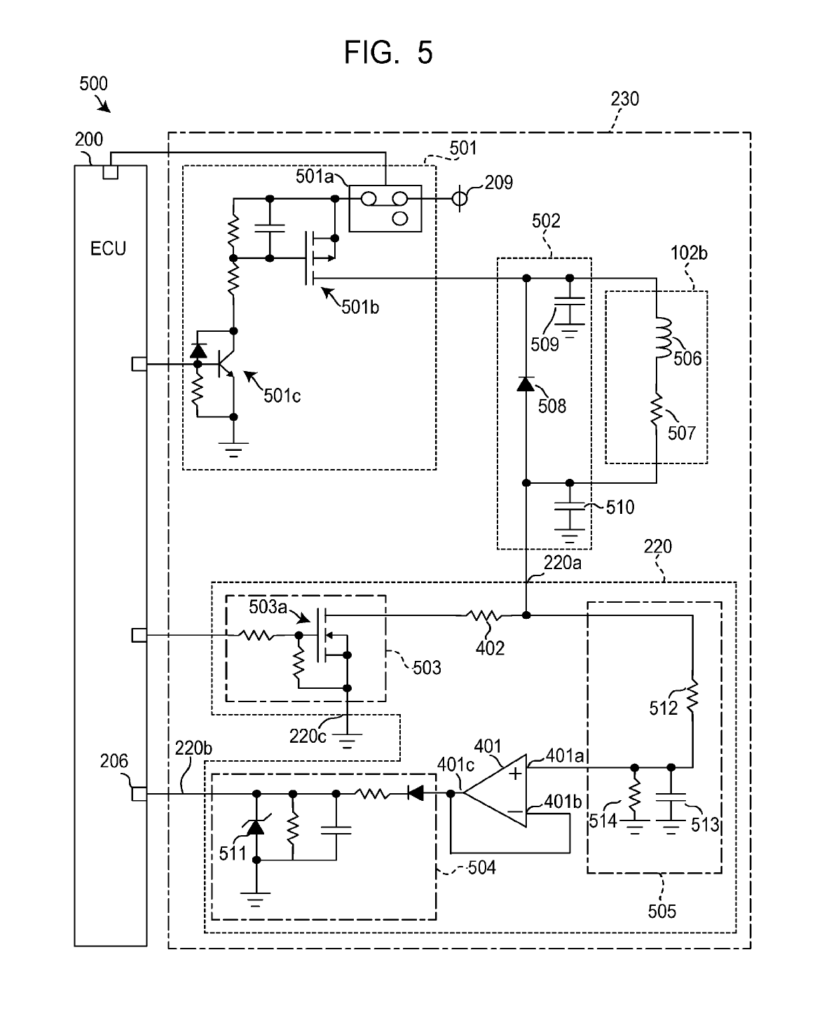

FIG. 5 illustrates a circuit 500 in which the more-detailed circuit configurations of the ECU 200 and the electromagnetic clutch circuit 230 are illustrated. The circuit 500 includes the ECU 200 and the electromagnetic clutch circuit 230. The electromagnetic clutch circuit 230 includes the electromagnetic clutch 102b, the power supply 209, the current detector circuit 220, an upstream current control circuit 501, and a stabilizer circuit 502.

The upstream current control circuit 501 is arranged on the way from the power supply 209 to the electromagnetic clutch 102b and the stabilizer circuit 502, and is also connected to the ECU 200. The upstream current control circuit 501 includes a switch 501a, a p-channel FET 501b, an npn-type transistor 501c, and so on. The switch 501a is connected at one terminal to the power supply, and is connected at the other terminal to a drain terminal of the FET 501b. The FET 501b is connected at a gate terminal to a collector terminal of the transistor 501c, and is connected at a source terminal to the electromagnetic clutch 102b and the stabilizer circuit 502. The transistor 501c is connected at a base terminal to the ECU 200, and is connected at an emitter terminal to the ground. The upstream current control circuit 501 amplifies a signal from the ECU 200 by means of the transistor 501c, and applies the amplified signal to the FET 501b, thereby controlling an amount of current flowing from the power supply 209 to the electromagnetic clutch 102b. The switch 501a turns on or off in response to a signal from the ECU, and thereby switches whether or not to allow the current to flow into the electromagnetic clutch 102b.

The stabilizer circuit 502 is connected in parallel to the electromagnetic clutch 102b between the upstream current control circuit 501 and the current detector circuit. The stabilizer circuit 502 includes a diode 508 connected in anti-parallel to the electromagnetic clutch 102b in order to prevent a failure of the circuit due to a counter electromotive force of the electromagnetic clutch 102b, and shunt capacitors 509, 510 for reducing noise.

The electromagnetic clutch 102b is connected in parallel to the stabilizer circuit 502 between the upstream current control circuit 501 and the current detector circuit. The electromagnetic clutch 102b can be considered equivalent to a series circuit in which a coil 506 and an equivalent series resistance 507 of the coil 506 are connected in series. A value of the equivalent series resistance 507 is determined depending on physical conditions of the coil 506 such as an electric resistivity, a wire thickness, and a wire length. For example, if the electric resistivity of the coil 506 increases due to the occurrence of an aging deterioration of the electromagnetic clutch 102b such as corrosion of the coil wire, the resistance value of the coil wire increases. Thus, on the equivalent circuit, such increase can be expressed as an increase in the equivalent series resistance 507. The current detector circuit 220 described above is capable of detecting an aging deterioration of the electromagnetic clutch 102b by detecting, as a change in the current value, a change in the resistance value of the equivalent series resistance 507.

The current detector circuit 220 further includes a downstream current control circuit 503, an output stabilizer circuit 504, and a noise elimination circuit 505 in addition to the operational amplifier 401 and the resistor 402 described above. The input terminal 220a of the current detector circuit 220 is connected to one terminal of the resistor 402, and one terminal of the noise elimination circuit 505. The other terminal of the resistor 402 is connected to the downstream current control circuit 503. The downstream current control circuit 503 is connected to the resistor 420, the ground, and the ECU 200. The other terminal of the noise elimination circuit 505 is connected to the non-inverting input terminal 401a of the operational amplifier 401. The inverting input terminal 401b of the operational amplifier 401 is connected to the output terminal 401c as described above, and thus the voltage follower circuit is constituted. The output stabilizer circuit 504 is connected between the output terminal 401c of the operational amplifier 401 and the signal input unit 206 of the ECU 200.

The downstream current control circuit 503 is connected between the resistor 402 and the ground, and includes an n-channel FET 503a and so on. The FET 503a controls the amount of current flowing from the electromagnetic clutch 102b to the ground in accordance with a signal from the ECU 200.

The noise elimination circuit 505 includes a series resistor 512, a shunt capacitor 513, and a shunt resistor 514. The noise elimination circuit 505 is a circuit capable of eliminating a noise component contained in a signal applied to the input of the operational amplifier. The noise elimination circuit 505 achieves denoising with its resistance values and capacitance value set to values that can give a time constant corresponding to a noise frequency component or the like. The configuration of the noise elimination circuit 505 is not limited to that illustrated in FIG. 5, but may be any suitable configuration selected.

The output stabilizer circuit 504 includes a zener diode 511 and so on. The output stabilizer circuit 504 limits the output voltage to be applied to the ECU 200 to a predetermined value (0 to 5 V, for example). Selection of the zener diode 511 having a predetermined breakdown voltage enables setting of the output voltage to a predetermined value. For example, if the output voltage is desired to be set to less than 5 V, a zener diode having a breakdown voltage of 5 V may be used. In addition, to stabilize the operation of the zener diode, a resistor and a capacitor may be arranged optionally as needed.

### <Control Method for Vehicle Open-Close Member>

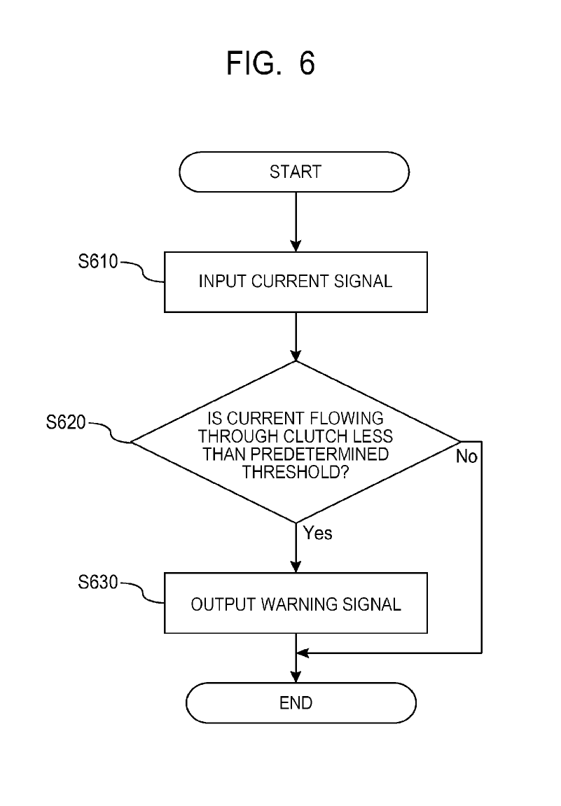

FIG. 6 presents a flow of a control method of detecting any of a failure and deterioration of the electromagnetic clutch 102b, and warning a user when the failure or deterioration is detected.

As described above, the output voltage from the current detector circuit 220 is inputted to the current signal input unit 206 of the ECU 200. In this control flow, this voltage is used as a current signal indicating an amount of current flowing through the electromagnetic clutch 102b. In step S610, the ECU 200 measures the voltage inputted to the current signal input unit 206.

In step S620, the ECU 200 judges the state of the electromagnetic clutch 102b by means of the clutch state judgement unit 204 based on the current flowing through the electromagnetic clutch 102b calculated from the voltage measured in step S610. If the current flowing through the electromagnetic clutch 102b is less than a predetermined threshold, the ECU 200 judges that the coil of the electromagnetic clutch 102b has a failure or a deterioration that is a precursory phenomenon of the failure, and advances to step S630. If the current flowing through the electromagnetic clutch 102b is more than the predetermined threshold, the ECU 200 judges that the coil of the electromagnetic clutch 102b does not have a failure or a deterioration that is a precursory phenomenon of the failure, and terminates the flow.

In step S630, the ECU 200 transmits a warning signal from the warning signal output unit 208, the warning signal causing the warning device 117 to issue a warning to a user.

The control device for a vehicle open-close member according to the present embodiment is capable of detecting the coil of the electromagnetic clutch having a failure and a deterioration that is a precursory phenomenon of the failure. Furthermore, the control device is capable of notifying the user that the coil of the electromagnetic clutch is in the state indicating a failure or a deterioration being the precursory phenomenon of the failure, and of encouraging the user to make repairs. If the coil exhibits a precursory phenomenon of a failure, in particular, the failure can be prevented previously by making the repairs before actual occurrence of the failure.

The control device for a vehicle open-close member according to the present embodiment offers fail-safe control that prevents the open-close member from opening despite the intention of a user. One conceivable example of the fail-safe control is a safety mechanism that, when a door latch of an open-close member is released despite the intention of a user while a vehicle is running, stops the open-close member from opening by engaging an electromagnetic clutch in response to a signal from the door latch. In such a safety mechanism, if the electromagnetic clutch has a failure, or comes to have a failure in an attempt to engage the electromagnetic clutch, the electromagnetic clutch cannot be engaged and may let the open-close member open despite the intention of the user. Hence, there is a demand for previous prevention of a failure of an electromagnetic clutch. The control device for a vehicle open-close member according to the present embodiment is capable of detecting the coil of the electromagnetic clutch having a failure or a deterioration that is a precursory phenomenon of the failure. Thus, the control device is capable of preventing a situation where the electromagnetic clutch is attempted to be engaged in response to a signal from the door latch, but fails to be engaged due to a failure in the clutch, and resultantly the open-close member opens despite the intention of a user.

The warning signal may further contain information indicating a degree of failure or deterioration of the coil of the electromagnetic clutch 102b. In this case, the warning device 117 can notify the user of the degree of the failure or deterioration, and the user can know the degree of the necessity or urgency for the repairs based on this information.

The threshold for the current used in step S620 for judging a failure or deterioration of the electromagnetic clutch 102b may be determined based on a change amount of the current value from the initial value. The change in the current value from the initial value may possibly indicate an aging deterioration of the coil of the electromagnetic clutch 102b. When the change amount of the current value from the initial value is used as a judgement criterion, such an aging deterioration can be detected more easily.

The threshold for the current used in step S620 for judging a failure or deterioration of the electromagnetic clutch 102b may be determined based on a change amount of the current value within a predetermined period of time. If the current value changes in a short period of time, this change may possibly indicate that an aging deterioration of the coil of the electromagnetic clutch 102b is rapidly progressing. When the change amount of the current value within the predetermined period of time is used as a judgement criterion, such rapid progress of an aging deterioration can be detected more easily.

The control flow explained above may be executed at any time when the electromagnetic clutch may possibly be operated. More specifically, the execution of the control flow may be repeated whenever necessary, or may be triggered by an event where a particular operation is performed. Specific possible examples of the particular operation are, for example, an operation of opening or closing the slide door 101, an operation of unlocking the door lock, an operation of turning on the engine of the vehicle, and so on.

### (Modification)

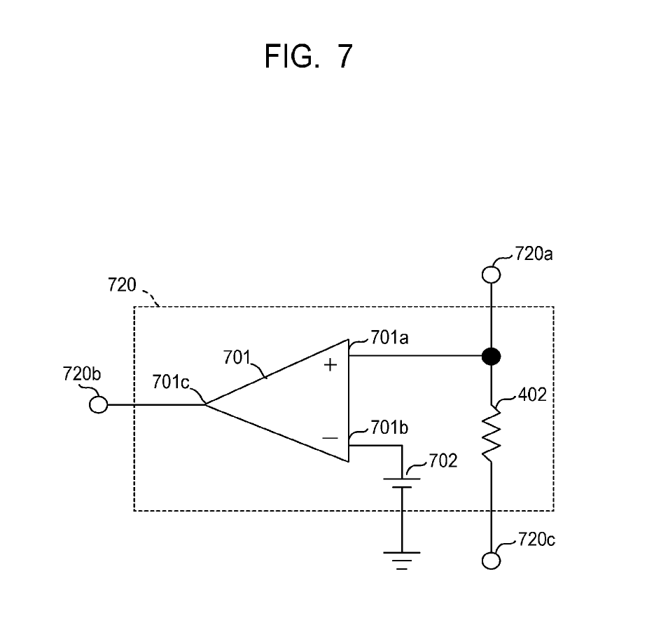

FIG. 7 illustrates a configuration of a current detector circuit 720 according to a modification. The current detector circuit 720 includes a comparator 701, a resistor 402, and a reference power supply 702. The comparator 701 includes a non-inverting input terminal 701a, an inverting input terminal 701b, and an output terminal 701c. The non-inverting input terminal 701a is connected to one terminal of the resistor 402, and constitutes an input terminal 720a of the current detector circuit 720. The inverting input terminal 701b is connected to a positive electrode of the reference power supply 702. A negative electrode of the reference power supply 702 is connected to the ground. The output terminal 701c of the comparator 701 constitutes an output terminal 720b of the current detector circuit 720. The other terminal of the resistor 402 constitutes a ground terminal 220c.

The reference power supply 720 is for supplying a reference voltage to the input terminal of the comparator. The reference power supply 720 may supply a voltage obtained from a power supply battery for reference, or may be supplied with a voltage from a power supply battery of the vehicle 100, for example, and supply a voltage obtained by dividing the supplied voltage at a predetermined ratio.

The current detector circuit 720 constitutes a comparator circuit including the comparator 701, and outputs a voltage signal from the output terminal 720b, the voltage signal being High when the voltage of the input terminal 720a of the current detector circuit 720 is higher than the voltage of the reference power supply 702, and being Low when the voltage of the input terminal 720a is lower than the voltage of the reference power supply 702. Since the comparator 701 has a sufficiently high input impedance, a current flowing from the input terminal 720a to the output terminal 720b in the current detector circuit 720 may be ignored. Thus, the current flowing through the resistor 402 is equivalent to the current flowing through the electromagnetic clutch 102b. In the configuration described above, the voltage outputted to the output terminal 720b of the current detector circuit 720 is High when Vr<IR and is Low when Vr>IR, where I denotes an current flowing through an electromagnetic clutch; R, the resistance value of the resistor 402; and Vr, the voltage of the reference power supply 702. In other words, the current detector circuit 720 is a circuit to judge whether the current flowing through the electromagnetic clutch is less than or more than a predetermined value. When the voltage outputted to the output terminal 720b is Low, it can be inferred that the amount of current flowing is reduced due to an increase in the resistance of the coil of the electromagnetic clutch 102b. In this case, it can be considered that a precursory phenomenon of a failure of the electromagnetic clutch 102b appears.

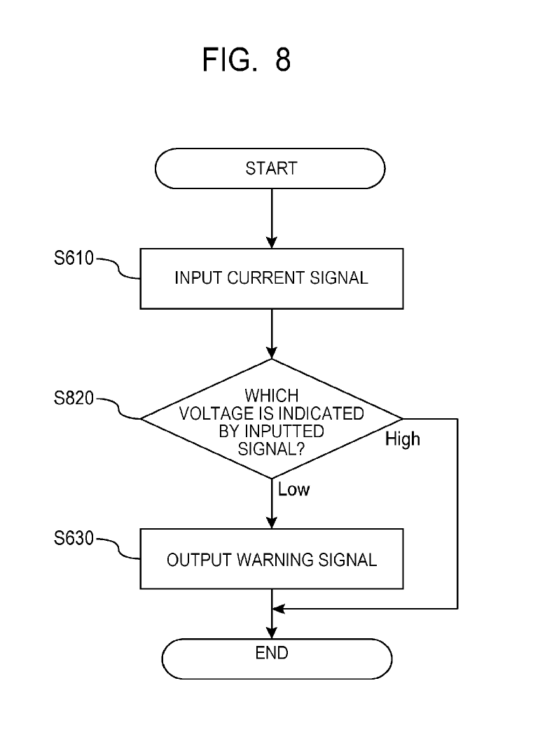

FIG. 8 presents a control flow in the case where the current detector circuit 220 in FIG. 3 is replaced with the current detector circuit 720 described above. Steps S610 and S630 are almost the same as in the flow previously described, and are omitted from the explanation below.

In step S820, the ECU 200 judges whether the inputted voltage is High or Low by means of the clutch state judgement unit 204. If the voltage is Low, the ECU 200 judges that the coil of the electromagnetic clutch 102b has a failure or a deterioration being a precursory phenomenon of the failure, and advances to step S630. If the voltage is High, the ECU 200 judges that the coil of the electromagnetic clutch 102b does not have a failure or a deterioration being a precursory phenomenon of the failure, and terminates the flow.

Also in this modification, it is possible to detect that the coil of the electromagnetic clutch has a failure and a deterioration being a precursory phenomenon of the failure, and to produce the same effect as in the first embodiment. Further, in this modification, the comparison with the threshold is made by the circuit, that is, the comparator 701 in place of the clutch state judgement unit 204. This makes the processing volume of the CPU less, so that the processing load can be reduced and the detection speed can be enhanced.

This application claims the benefit of priority from Japanese Patent Application No. 2013-224063 filed on Oct. 29, 2013, the contents of which are incorporated by reference as part of the description of this application.

### EXPLANATION OF THE REFERENCE NUMERALS

100 vehicle
102b electromagnetic clutch
107 warning device
200 ECU (control device)
204 clutch state judgement unit
205 input circuit
206 current signal input unit
207 output circuit
208 warning signal output unit
209 power supply

1. A control device for a vehicle open-close member, comprising:
a current signal input unit configured to receive an inputted current signal indicating a current value of a current flowing through an electromagnetic clutch of the vehicle open-close member, the electromagnetic clutch being operated with the current supplied from a power supply;
a clutch state judgement unit configured to judge that the electromagnetic clutch is in a deteriorated state, when the current signal indicates that the current value is less than a predetermined threshold; and
a warning signal output unit configured to output a warning signal to a warning device configured to give a warning to a user, when the clutch state judgement unit judges that the electromagnetic clutch is in the deteriorated state.

2. The control device for a vehicle open-close member according to claim 1, wherein
the signal indicating the current value is a signal of a voltage value to which the current value is converted by a current-voltage convertor circuit, and
the clutch state judgement unit judges that the electromagnetic clutch is in the deteriorated state based on the voltage value.

3. The control device for a vehicle open-close member according to claim 1, wherein
the current signal is a signal of any of first and second voltage values, the first voltage value indicating that the current value is more than the threshold, the second voltage value indicating that the current value is less than the threshold, and
the clutch state judgement unit judges that the electromagnetic clutch is in the deteriorated state when the current signal indicates the second voltage value.

4. The control device for a vehicle open-close member according to claim 1, wherein the threshold is determined based on a change amount of the current value within a predetermined period of time.

5. A control method for a vehicle open-close member, comprising:
inputting a current signal indicating a current value of a current flowing through an electromagnetic clutch of the vehicle open-close member, the electromagnetic clutch being operated with the current supplied from a power supply;
judging that the electromagnetic clutch is in a deteriorated state, when the current signal indicates that the current value is less than a predetermined threshold; and
outputting a warning signal to a warning device when it is judged that the electromagnetic clutch is in the deteriorated state.

6. A vehicle open-close member comprising:
an electromagnetic clutch configured to be operated with a current;
a current detector circuit configured to detect the current flowing through the electromagnetic clutch;
a control device configured to receive an inputted current signal indicating a current value detected by the current detector circuit, and outputting a warning signal when the current signal indicates that the current value is less than a predetermined threshold; and
a warning device configured to issue a warning to a user when the warning signal is inputted to the warning device.
